(19) United States
(12) Patent Application Publication
(10) Pub. No.: US 2020/0331711 A1
(43) Pub. Date: Oct. 22, 2020

(54) STACKING DEVICE

(71) Applicant: ROBOJOB N.V., Heist-op-den-Berg (BE)

(72) Inventors: Helmut DE ROOVERE, Keerbergen (BE); Luc DE CEUSTER, Herselt (BE)

(73) Assignee: ROBOJOB N.V., Heist-op-den-Berg (BE)

(21) Appl. No.: 16/487,124

(22) PCT Filed: Feb. 27, 2018
(86) PCT No.: PCT/BE2018/000003

§ 371 Date: Aug. 20, 2019

(30) Foreign Application Priority Data
Feb. 28, 2017 (BE) BE2017/5122

(51) Int. Cl. B65G 57/03; B65G 61/00

(52) U.S. Cl. CPC B65G 57/03; B25J 9/1679; B65G 61/00

(57) ABSTRACT

Device for carrying workpieces in a plurality of stacks, including a frame and a plate-like carrier with a plurality of pegs positioned in a pattern. The pattern is related to the plurality of stacks. The plurality of pegs extend substantially at right angles relative to the plate-like carrier. The plate-like carrier is positioned at an angle relative to the ground surface. In use the stacks lean against the pegs in order to position the workpieces against the pegs. The device is configured to be operatively coupled to a robot arm which is adapted to place the workpieces on the stacks and/or take them from the stacks. At least a predetermined number of the plurality of pegs is formed with at least one flat side in section, so that a workpiece can be positioned against the flat side of the pegs.

The invention relates to a device for carrying workpieces above a ground surface, wherein the device further has a plate-like carrier with a plurality of pegs positioned in a pattern, which pattern is related to the plurality of stacks, and extending substantially at right angles relative to the plate-like carrier, and wherein the plate-like carrier is positioned at an angle relative to the ground surface, all this such that in use the stacks lean against the pegs in order to thus position the workpieces against the pegs, wherein the device is configured to be operatively coupled to a robot arm which is adapted to place the workpieces on the stacks and/or take them from the stacks.

Such a device is known from EP 2 314 414 of the same applicant. The advantage of the device is twofold. One the one hand, workpieces can be located in simple manner on the basis of spatial coordinates. This is a direct result of the construction of the device and of the stacks leaning against the pegs. This allows a robot arm with gripper to easily handle the workpieces on the basis of the coordinates. This technique is suitable in for instance machining work, wherein the workpieces are transported into and/or out of a processing machine, such as a CNC machine, tool by means of a robot arm.

A second considerable advantage of this device is related to the stackability of the workpieces. Because the workpieces are on the one hand placed on the plate-like carrier and on the other hand lean against the pegs, a plurality of workpieces can be stacked on each other in simple manner, wherein the position of each of the workpieces in the stack is defined unambiguously. It is apparent here that the position is defined unambiguously because the position of the plate-like carrier, of the pegs and the angle of the plate-like carrier relative to the ground surface are known. By stacking workpieces the space around a robot can be configured efficiently for storage of the workpieces. This allows a large number of workpieces to be stored in a compact space around a machine, for instance a machining device.

A drawback of the device of EP 2 314 414 relates to the stacking and positioning of workpieces with a more complex shape. The device is optimal for stacking of workpieces with a substantially circular section, wherein for each stack two pegs are provided for unambiguously positioning the workpieces in the stack thereby. When workpieces with a section differing from a circular section however have to be positioned, more than two pegs will have to be provided per stack in a pattern such that the workpieces lean against the more than two pegs in order to thus be positioned unambiguously. This requires the pegs to be precisely placeable and/or displaceable subject to the size and shape of the workpieces in order to be able to realize the above, which is expensive and technically complex. Configuring the device for the purpose of enabling unambiguous stacking of a complex workpiece also requires complex and precise operations, which is time-consuming and prone to errors.

It is an object of the invention to optimize the device for stacking workpieces with a shape, preferably a sectional shape, which differs from a circle.

The device according to the invention is characterized for this purpose in that at least a predetermined number of the plurality of pegs is formed with at least one flat side in section, so that a workpiece can be positioned against the flat side of the pegs.

The invention is based on the insight that in the majority of cases workpieces with a sectional shape differing from a circular shape have a flat side on at least a portion of their periphery. A simple example is a workpiece with a rectangular section, wherein the corners are optionally rounded. By forming at least a number of the pegs in the device with at least one flat side in section, workpieces having a flat side on their periphery, referred to hereafter as ‘flat peripheral side’, can be placed with their flat peripheral side against the flat side of the pegs. The angular position of the workpiece is hereby predetermined because the flat peripheral side of the workpiece comes to lie parallel to the flat side of the peg. A further peg can be provided here in order to support a further peripheral part of the workpiece and thus unambiguously define the position of the workpiece on the device using only two pegs.

The device according to the invention allows workpieces with a sectional shape differing from a circular shape to be positioned unambiguously in simple manner, wherein only two pegs are needed for each stack. The skilled person will appreciate that in a prior art device three pegs have to be provided per stack of workpieces in order to enable unambiguous positioning of workpieces with for instance a rectangular section. In the device according to the invention only two pegs are necessary for unambiguous positioning of workpieces with a rectangular section, wherein at least one of the two pegs has a flat side which is oriented relative to the rectangular workpieces for predetermining the angular position of the rectangular workpieces. This simplifies the use and configuration of the device according to the invention. It further also allows the stacks of workpieces to be distributed in a more efficient manner over the surface of the device so that more workpieces can be carried by the device.

The flat side preferably extends over substantially the whole length of each of the predetermined number of the plurality of pegs. When the flat side extends over substantially the whole length of the peg, workpieces can be positioned against the peg over substantially the whole height of the peg. This allows all workpieces of a stack to be laid against the flat side of the peg.

Each of the predetermined number of the plurality of pegs further preferably has at least partially the shape of a circle segment in section. More specifically, each of the predetermined number of the plurality of pegs is circle segment-shaped in section. By making the pegs circle segment-shaped it is possible during configuration of the device and/or during forming of the pattern to choose in each case whether the peg will be directed with its flat side toward the workpiece, so that the workpiece lies against the flat side of the peg, or will be directed with its round side toward the workpiece, so that the workpiece lies against the round side of the peg. As seen in a sectional view, the workpiece will be in point contact with the peg when the peg is directed with its round side toward the workpiece. When the peg is directed with its flat side toward the workpiece and when the workpiece has a flat peripheral side, the workpiece can lie with its flat peripheral side against the flat side of the peg, so that a line contact is obtained in section. The circle segment-shaped section of the pegs makes it possible to determine the manner in which the workpieces are placed against the pegs as desired.

At least the predetermined number of the plurality of pegs is preferably connected in orientable manner to the plate-like carrier so that the orientation of the flat side relative to the stacks is adjustable. Orientable is preferably further defined here as rotatable, wherein the peg is rotated about its longitudinal axis and can be fixed in a fmal rotation position so that the orientation of the peg is defined. Depending on the situation, the pegs can be oriented with the flat side so as to thereby be optimally positioned relative to the workpieces.

Each flat side preferably has a width of at least 1 cm, more preferably at least 2 cm. The width of the flat side is considered the length of the chord of the circle segment when viewing the section of the peg. By making the flat side wide enough, preferably at least 1 cm, more preferably at least 2 cm, workpieces will have a greater tendency, and will tend more readily, to lie with their flat peripheral side against the flat side of the pegs. It is desirable here that the workpieces automatically take up their unambiguous position relative to the device as a result of the force of gravity. This effect can be intensified by making the flat side sufficiently wide.

At least one peg of the predetermined number of the plurality of pegs is preferably provided for each of the plurality of stacks. The predetermined number of the plurality of pegs are defined as the pegs with the at least one flat side in section. By providing at least one such peg at each stack, workpieces of each stack can lean with a flat peripheral side against the flat side of the peg in order to thus be positioned.

A distance with which the pegs extend above the plate-like carrier is preferably adjustable by means of an actuator. The effect is that the top end points of the pegs can be set at different heights relative to the plate-like carrier by means of the actuator. This allows the device to make the distance between the upper side of the pegs and the plate-like carrier substantially equal to the height of the stacks. The robot can hereby in each case take up or set down the workpieces from or on the stacks at the position of the upper side of the pegs, so that the pegs do not collide with the gripper of the robot. Workpieces are typically gripped around their periphery, wherein the robot arm is provided with a head comprising this gripping mechanism. This head is typically too thick to move between the pegs. By adjusting the distance over which the pegs extend, the gripper of the robot is always able to handle the workpieces at the position of an upper side of the pegs so that collisions are avoided.

The pegs are preferably mounted on a mounting plate provided under the plate-like carrier, and wherein the plate-like carrier has openings for the pegs and wherein the plate-like carrier can be moved upward and downward relative to the mounting plate via the actuator. The plate-like carrier is hereby movable relative to the mounting plate, which is preferably fixed, or is fixed during operation of the device. Because the pegs are mounted on the mounting plate, the pegs will also be fixed, whereby the spatial coordinates of the top end points of the pegs are known. By moving the plate-like carrier workpieces can be pushed up to the upper side of the pegs by moving the plate-like carrier upward, or space can be provided for placing a further workpiece by lowering the plate-like carrier.

The plurality of pegs are preferably displaceable relative to the plate-like carrier in order to adjust the pattern to the workpieces. A matrix can for this purpose be provided with holders for receiving the pegs. By giving the pegs a displaceable form, the pegs can be positioned such that the stacks can be placed efficiently and close together on the carrier of the device. The space can thus be used efficiently for carrying a maximum number of workpieces.

The device preferably comprises at least two zones which can be controlled separately so that the one zone can be controlled for placing the workpieces on the stacks and a further zone can be controlled for taking the workpieces from the stacks. The two zones have a substantially analogous construction, wherein the pegs have an analogous pattern and wherein the plate-like carrier is configured in the one zone to move from top to bottom and is configured in the other zone to move from bottom to top. This makes it possible to use one device for supplying the not yet processed workpieces via the robot and for carrying away the processed workpieces via the robot.

The invention further relates to a set of a device as described above and a robot arm, wherein the robot arm is operatively coupled to the device and wherein the robot arm is adapted to place the workpieces on the stacks and/or take them from the stacks.

The invention will now be further described on the basis of an exemplary embodiment shown in the drawing.

In the drawing:

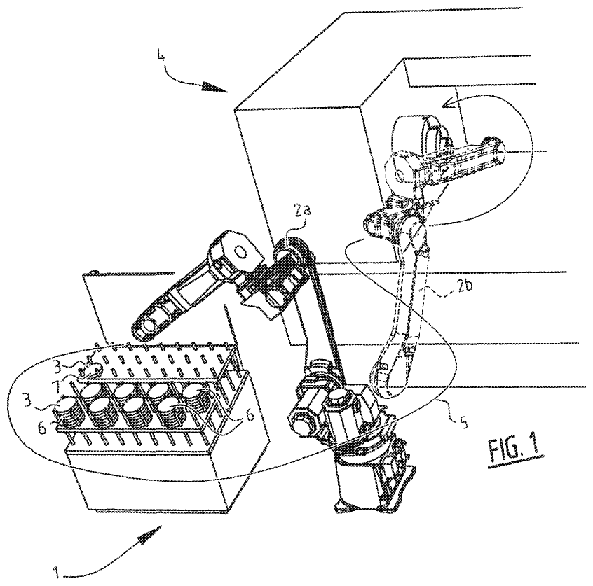

FIG. 1 shows a device according to an exemplary embodiment of the device in its context of use;

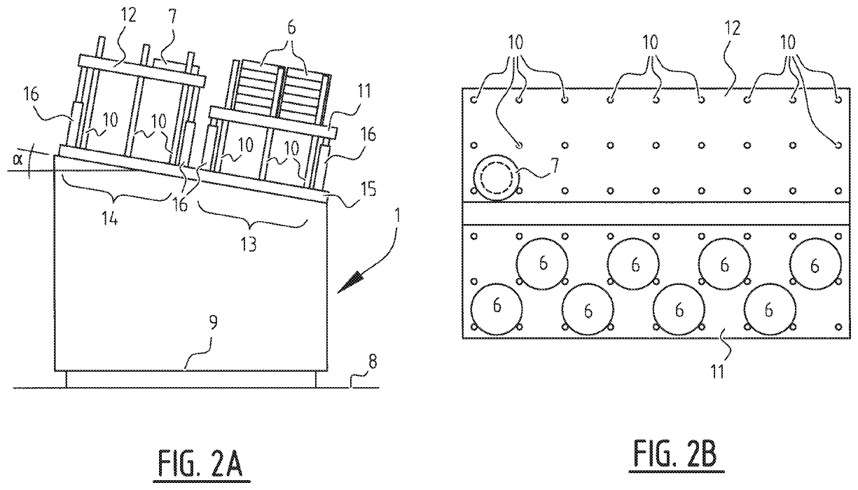

FIG. 2 shows a side view and top view of a device according to an embodiment of the invention;

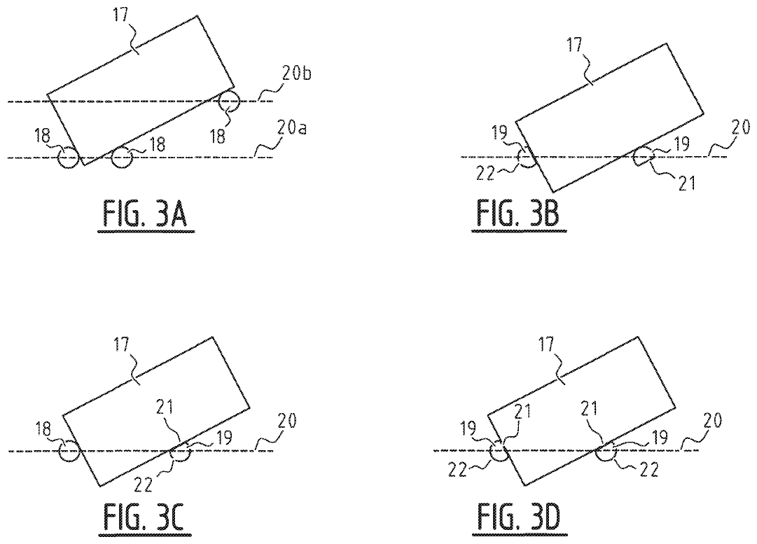

FIG. 3 shows a top view of a plurality of configurations of pegs for positioning workpieces; and

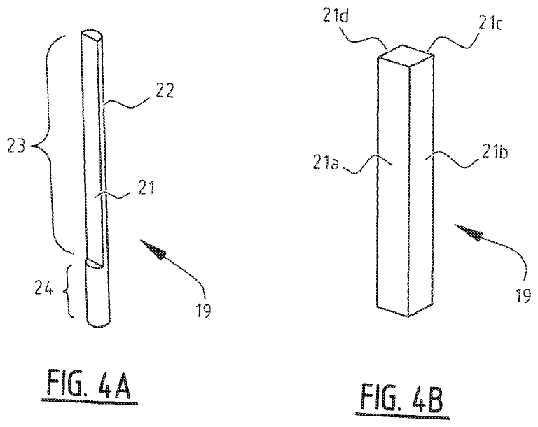

FIG. 4 shows a perspective view of a plurality of pegs which can be applied in the device according to the invention.

The same or similar elements are designated in the drawing with the same reference numerals.

Peg is defined as an elongate object which can take a hollow or solid form. The peg preferably has a constant section along its length.

FIG. 1 shows a device 1 placed in an operative context. This means that FIG. 1 shows an example of a combination of apparatuses and/or machines which allow device 1 to function optimally. Device 1 was developed to carry a plurality of stacks of workpieces 3. The invention has for its object to allow a robot 2, which is preferably formed substantially by a robot arm, to handle the workpieces in simple manner. This object is achieved with the device 1 in that workpieces 3 are carried at pre-known positions. This will be further elucidated hereinbelow.

Robot 2 typically comprises a robot arm with a gripper. The robot can grip workpieces 3 via the gripper. The robot arm of robot 2 is preferably configured to move above the whole device 1 in order to be able to reach all the stacks being carried on device 1. The robot arm is preferably further configured to be able to move toward a processing machine 4 in order to transport workpieces into and/or out of processing machine 4. Examples of processing machines which workpieces can be transported both into and out of are lathes, CNC machines, drilling machines and other traditional machining devices. Device 1 can also be used in situations in which workpieces are only removed from a processing machine, for instance a 3D printing machine. The 3D-printed workpieces can herein be removed from the 3D printer by robot 2 and be placed on stacks on device 1. Device 1 can further be applied in situations in which workpieces need only be fed to a processing machine. The workpieces are then carried by device 1 in stacks, and transported from the stacks to the processing machine by robot 2.

The movement of the robot arm is illustrated with line 5 in FIG. 1. In the figure the robot is shown in two positions. A first position is designated with reference numeral 2A and shows the robot while taking up a workpiece 3 from a stack of device 1. The robot is further shown in a second position, designated with reference numeral 2B, in which the robot places the workpiece in the processing machine. On the basis of this figure the skilled person will appreciate that such a configuration, including the device according to the invention, allows workpieces to be transported into and/or out of the processing machine from and to a plurality of stacks on device 1 in a wholly or partially automated manner.

FIG. 1 further shows a lower series of stacks, designated with reference numeral 6, in which the workpieces to be processed are stacked. The figure further shows a second series of stacks, designated with reference numeral 7, in which the processed workpieces are stacked. The way in which these stacks can be provided on the device so as to achieve optimal operation of the device will be further discussed hereinbelow.

FIG. 2 shows a section of the device according to a preferred embodiment of the invention. FIG. 2 illustrates here how device 1 comprises a frame 9 with which device 1 is placed on a ground surface 8. Alternatively, frame 9 can be mounted on a wall or other support structure, so that frame 9 is carried above a ground surface 8. FIG. 2 further shows the plate-like carriers 11 and 12. In device 1 of the embodiment of FIG. 2 a first plate-like carrier 11 is provided in a first zone 13 of device 1 and a second plate-like carrier is provided in a second zone 14 of device 1. It is alternatively also possible for only one plate-like carrier to be provided. As already described above, and as is illustrated in FIG. 2, one device 1, subdivided into two zones 13 and 14, can be optimized for both feeding workpieces and carrying away workpieces to and from a processing machine. In FIG. 2 stacks 6 are provided with workpieces for feeding to the processing machine and stack 7 is provided for carrying workpieces away from the processing machine. The skilled person will appreciate that a plurality of subdivisions and configurations are possible for forming the device.

Device 1 comprises a plurality of pegs 10 extending perpendicularly above plate-like carriers 11 and 12. Plate-like carriers 11 and 12 are placed at an angle a relative to ground surface 8. The result of this construction, as is clearly illustrated in FIG. 2, is that, due to the force of gravity, stacks 6, 7 not only support on plate-like carrier 11 but also lean against pegs 10. The position of the workpieces in the space can hereby be defined unambiguously. This allows robot 2 to be controlled on the basis of position, which can be realized in simple manner. Complex workpiece detection systems on the basis of sensors, for instance cameras, are hereby unnecessary.

Pegs 10 are preferably positioned fixedly relative to frame 9 so that the spatial position of the pegs is known, and whereby the position of the stacks of workpieces is also at least partially known. Plate-like carriers 11 and 12 can further be moved upward and downward via actuators 16. The height of plate-like carrier 11 and 12 is preferably known here, for instance because actuators 16 are position-controlled or because sensors are provided for determining the height. The spatial orientation of stacks 6 and 7 is known unambiguously owing to the combination of the knowledge of the height of plate-like carriers 11, 12 and of the position of pegs 10. The dimensions and quantities of the workpieces forming part of stacks 6 and 7 are preferably further known here, so that the height of stacks 6 and 7 is also known. On the basis hereof, the coordinates of the top workpiece of stacks 6 and 7 can be defined unambiguously so that the robot can be controlled on the basis of these coordinates. Pegs 10 can alternatively be movable upward and downward, while plate-like carrier 11, 12 is fixed. The skilled person will appreciate that in such a configuration the coordinates of the upper workpiece of the stack can likewise be defined unambiguously. To further explain the general operating principles of the device, EP2314414 is incorporated in this description by reference.

In the configuration of FIG. 2 pegs 10 are mounted on a mounting plate 15 extending under plate-like carriers 11 and 12. Plate-like carriers 11 and 12 have openings so that the pegs can extend through these carriers. Plate-like carriers 11 and 12 can further move relative to mounting plate 15 so that the distance between the upper side of pegs 10 and the plate-like carrier is adjustable, for instance taking into consideration the height of stacks 6, 7. As explained above, the object is here to allow a robot to always handle, i.e. take up or set down, workpieces at the position of an upper side of pegs 10 so that the gripper of the robot does not collide with pegs 10.

On the basis of FIG. 2 the skilled person will appreciate that different subdivisions can be provided in the device, wherein the device may comprise one, two or more than two zones which can be configured and controlled independently of each other. This means that the pattern of the pegs can differ in different zones of the device, and that the height of the pegs relative to the plate-like carriers can be individually controllable in different zones. Device 1 can hereby be used flexibly.

FIG. 2 shows a top view of device 1 on its right-hand side, wherein the view is perpendicular to plate-like carriers 11 and 12. This means that the view shown on the right-hand side of FIG. 2 is oriented at an angle α relative to the downward direction. The figure illustrates how a plurality of stacks 6 can be provided on first plate-like carrier 11 and how a plurality of stacks 7, of which only one stack is shown, can be provided on second plate-like carrier 12. The pattern in which pegs 10 are formed relative to plate-like carrier 11 and 12 determines here the position and orientation of stacks 6 and 7 which are carried by plate-like carriers 11 and 12. The pattern is preferably formed such that a set of pegs is provided for each stack for the purpose of supporting the stack. The mutual distance between the different stacks 6 and 7 and, with this, the efficiency of use of the available space, is determined by the pattern.

In FIG. 2 a pattern is formed by pegs having a substantially circular section. Such pegs are optimal for positioning stacks of round workpieces. Round workpieces are defined here as workpieces with a substantially circular section, as shown in FIG. 2. The skilled person will appreciate that in the case of circular workpieces the angular position of the workpiece relative to the device is irrelevant to the gripping of the workpiece by a robot. The gripper of the robot is typically provided with a plurality of fingers, preferably three fingers, which can be placed around a periphery of the workpiece in order to thus clamp the workpiece between the fingers by moving the fingers. In the case of round workpieces the angular position of the workpiece is irrelevant to the correct gripping of the workpiece. This is different in the case of non-round workpieces.

FIG. 3A shows a workpiece with a section with a shape differing from a circular shape, and makes clear that at least three round pegs must be provided for unambiguous positioning of such a workpiece. This means that when only round pegs are used for positioning a stack of such non-round workpieces, a set of at least three pegs must be provided at each stack.

FIG. 3 shows a rectangular workpiece 17 and illustrates a plurality of embodiments for unambiguously defining the position of rectangular workpiece 17. FIG. 3A illustrates here an embodiment wherein only pegs with a round section are used. The figure makes clear that three of such pegs are necessary in order to unambiguously define the position and orientation. If only two pegs with a round section were to be provided, the angular position of the workpiece cannot be maintained. More specifically, relative to only two round pegs workpiece 17 is able to rotate, such that the peripheral sides of workpiece 17 take up a different spatial position. This is problematic when a robot is controlled for gripping workpiece 17 on the basis of coordinates.

FIG. 3A further illustrates that for unambiguously positioning a non-round workpiece 17 using round pegs 18, the pegs 18 have to be provided on different mounting lines. FIG. 2 shows on the right-hand side that the pegs are placed on a grid, typically comprising a plurality of rows and columns, wherein each row can be deemed a mounting line 20 for mounting of pegs. Mounting pegs on a plurality of mounting lines for the purpose of supporting one stack of workpieces complicates the construction and use of device 1. In the context of this description a non-round workpiece is preferably defined as a workpiece wherein, when viewing the workpiece in section, at least a part of its peripheral side is flat. In the context of this description a section of the workpieces oriented perpendicularly of the stacking direction along which the height of the stack is measured is here viewed in each case.

FIGS. 3B, 3C and 3D show embodiments which demonstrate that making use of pegs with a flat side provides a solution to the above described drawbacks. In each of the FIGS. 3B-3D at least one of the pegs is turned with its flat side 21 toward the workpiece. This allows workpiece 17 to lie with a flat peripheral side against the flat side 21 of peg 19. As described above, the angular position of workpiece 17 is thereby predetermined. As a result, a non-round workpiece 17 can be positioned unambiguously by only two pegs.

FIG. 3C shows an embodiment wherein one of the two pegs, designated with peg 18, has a round section, and another of the two pegs, designated with reference numeral 19, has a flat side 21. In FIGS. 3B, 3C and 3D the pegs with flat side 21 have a circle segment-shaped section, whereby the pegs have a round side 22 opposite flat side 21.

FIG. 3B shows an embodiment wherein both pegs have a flat side, but wherein only one of the two pegs is directed with its flat side 21 toward workpiece 17, and wherein the other of the pegs with flat sides 19 is directed with its convex side 22 toward workpiece 17. FIG. 3D shows a further alternative embodiment wherein both pegs have a flat side and both pegs are directed with their flat side 21 toward workpiece 17. On the basis of FIGS. 3B-3D the skilled person will understand how the unambiguous position is achieved. FIGS. 3B, 3C and 3D further illustrate that the pegs with flat side can be positioned on one mounting line 21 in order to unambiguously position the workpieces, which allows an optimal configuration of the device.

FIGS. 3B-3D further illustrate that it can be advantageous to provide the pegs rotatably and/or displaceably in device 1. Providing the pegs rotatably allows the angular position of flat side 21 of pegs 19 to be directed optimally toward workpiece 17. By further making the pattern and the position and/or the optional presence of a peg at each grid point of the grid adjustable it is possible to obtain an optimal distribution of workpieces and stacks on the device.

FIG. 4 shows two exemplary embodiments of pegs with a flat side. FIG. 4A shows here a peg 19 which is provided with a flat side 21, wherein the flat side 21 extends over the greater part of the height of the peg. More specifically, the flat side 21 extends over an operating height 23 of peg 19. Operating height is defined here as the portion of the peg which in normal use of device 1 is configured to lean against the workpieces of a stack which are placed on device 1. Peg 19 can be given an alternative design on a lower side so as to enable mounting and detaching as well as rotating of the peg in device 1. In FIG. 4A the lower side of peg 19 is designated with reference numeral 24. Peg 19 of the embodiment of FIG. 4A has a round side opposite flat side 21. The peg has a circle segment-shaped section. A circle segment is defined here as a part of the circle area which is enclosed between a circular arc and the chords between the end points of that circular arc. The circle segment preferably forms at least half of the circle of which the circle segment is a segment.

FIG. 4B shows an alternative embodiment wherein peg 19 has a square section and thus has four flat sides 21A, 21B, 21C and 21D. The skilled person will appreciate that peg 19 can be formed in many ways in order to achieve the effect described above and illustrated in FIG. 3. A hollow tube can thus form the basis for peg 19, wherein a circular arc is removed from the tube, as seen in a sectional view, similarly to the peg of FIG. 4A. In contrast to the peg of FIG. 4A, the tube will be hollow and no physical surface will extend between the end points of the circular arc. However, because the tube has at the position of the end points of the circular arc, which are situated at a distance from each other, two contact lines suitable for supporting workpiece 17, a workpiece 17 can lie against these two contact lines so that the same function is obtained in the same manner and with the same result. The hollow open side of the tube can therefore be functionally considered the flat side 21 of the tube.

The skilled person will appreciate on the basis of the above description that the invention can be embodied in different ways and on the basis of different principles. The invention is not limited to the above described embodiments. The above described embodiments and the figures are purely illustrative and serve only to increase understanding of the invention. The invention will not therefore be limited to the embodiments described herein, but is defined in the claims.

### LIST OF REFERENCE NUMERALS

1. device

2. robot arm

3. workpiece

4. processing machine

5. movement

6. first stack

7. second stack

8. ground surface

9. frame

10. pegs

11. first plate-like carrier

12. second plate-like carrier

13. first zone

14. second zone

15. mounting plate

16. actuator

17. non-round workpiece

18. round peg

19. peg with flat surface

20. mounting line

21. flat side

22. round side

23. operating height

24. mounting height

α. angle

1. A device for carrying workpieces in a plurality of stacks above a ground surface, comprising:
a plate-like carrier with a plurality of pegs positioned in a pattern, which pattern is related to the plurality of stacks, and wherein the plurality of pegs extend substantially at right angles relative to the plate-like carrier,
wherein the plate-like carrier is positioned at an angle relative to the ground surface, so that in use the stacks lean against the pegs in order to position the workpieces against the pegs,
wherein the device is configured to be operatively coupled to a robot arm which is adapted to at least one of place the workpieces on the stacks and take the workpieces from the stacks,
wherein at least a predetermined number of the plurality of pegs is formed with at least one flat side in section, so that a workpiece can be positioned against the flat side of the pegs.

2. The device according to claim 1, wherein the flat side extends over substantially the whole length of each of the predetermined number of the plurality of pegs.

3. The device according to claim 1, wherein each of the predetermined number of the plurality of pegs further has at least partially the shape of a circle segment in section.

4. The device according to claim 1, wherein at least the predetermined number of the plurality of pegs is configured in an orientable manner relative to the plate-like carrier so that the orientation of the flat side relative to the stacks is adjustable.

5. The device according to claim 1, wherein each flat side has a width of at least 1 centimetre.

6. The device according to claim 1, wherein at least one peg of the predetermined number of the plurality of pegs is provided for each of the plurality of stacks.

7. The device according to claim 1, wherein a distance with which the pegs extend above the plate-like carrier is adjustable by means of an actuator.

8. The device according to claim 7, wherein the plurality of pegs are mounted on a mounting plate provided under the plate-like carrier, and wherein the plate-like carrier has openings for the pegs, and wherein the plate-like carrier can be moved upward and downward relative to the mounting plate via the actuator.

9. The device according to claim 1, wherein the plurality of pegs are displaceable relative to the plate-like carrier in order to adjust the pattern to correspond to the workpieces.

10. The device according to claim 1, wherein the device comprises at least two zones which that are separately controllable so that the one zone can be controlled for placing the workpieces on the stacks and a further zone can be controlled for taking the workpieces from the stacks.

11. A set of a device according to claim 1 and a robot arm, wherein the robot arm is operatively coupled to the device and wherein the robot arm is adapted to at least one of place the workpieces on the stacks and take the workpieces from the stacks.
